(19) United States
(12) Patent Application Publication
(10) Pub. No.: US 2002/0050791 A1
(43) Pub. Date: May 2, 2002

(54) Plasma display panel

(76) Inventors: Won-Tae Lee, Kyungki-do (KR); Young-Soo Park, Kyungki-do (KR); Ki-Young Kim, Kyungki-do (KR); Hidekazu Hatanaka, Kyungki-do (KR); Je-Youn Choung, Kyungki-do (KR)

Correspondence Address: Charles F. Wieland III, BURNS, DOANE, SWECKER & MATHIS, L.L.P., P.O. Box 1404, Alexandria, VA, 22313-1404, US

(21) Appl. No.: 09/794,095

(22) Filed: Feb. 28, 2001

(30) Foreign Application Priority Data
Oct. 31, 2000 (KR) 00-64216

(51) Int. Cl. H01J 17/49

(52) U.S. Cl. 313/586; 313/587

(57) ABSTRACT

The present invention discloses a plasma display panel. The disclosed panel comprises front and rear substrates that face each other with a certain distance apart, and on the facing sides of the front and rear substrates, a plurality of first and second electrodes are formed. On the first electrodes and the rear substrate a first dielectric layer is formed, between the first electrodes on the first dielectric layer barrier ribs are formed with a predetermined height, and on the sides of the barrier ribs and on the upper side of the first dielectric layer a fluorescent layer is coated. Over the second electrodes and the front substrate a second dielectric layer with an energy band gap of 6 eV or more and a dielectric constant of less than 10 is formed. Therefore, by forming a dielectric layer having high breakdown voltage and excellent interface characteristics on the front substrate, breakdown can be reduced, and as a result, the cost of manufacturing a large quantity of plasma display panels can be reduced by improving the yield of non-defective panels, and the lifetime of the panel can be extended.

### BACKGROUND OF THE INVENTION

1. Field of the Invention

The present invention relates to a plasma display panel, and more particularly, to a plasma display panel where a dielectric layer on a front substrate is improved.

2. Description of the Related Art

In general, a plasma display panel displays an image using a gas discharge phenomenon, and its display features such as a display capacity, a brightness, a contrast, an afterimage, and a viewing angle are excellent and the panel is in the spotlight as a display device that can be substituted for a CRT.

In the plasma display panel, discharge is generates in gas between electrodes by a direct current (DC) or an alternating current (AC) that is applied to the electrodes and the radiation of ultra-violet rays excites a fluorescent material, thus emitting light.

A plasma display panel may be of a DC type or an AC type, depending on the form of driving voltage, for example, the type of discharge. A DC type plasma display panel has a structure where all electrodes are exposed to a discharge space and charged particles move directly between corresponding electrodes. In an AC type plasma display panel, at least one electrode is covered with a dielectric layer and charged particles do not move directly between corresponding electrodes but instead, discharge is performed by a wall charge.

An example of an AC type plasma display panel is shown in FIG. 1.

Referring to FIG. 1, first electrodes 13a are formed in stripes on the inner side of a rear substrate 11, and a first dielectric layer 14 is formed to cover the first electrodes 13a on the upper surface of the rear substrate 11 where the first electrodes 13a are formed. On the upper surface of the first dielectric layer 14 between the first electrodes 13a are formed barrier ribs 15 that keep a discharge distance and that prevent cross talk between discharge cells 19 from occurring.

A front substrate 12 is joined to the rear substrate 11 where the barrier ribs are formed, and second electrodes 13b of a stripe type that are perpendicular to the first electrodes 13a are formed on the facing side. On the lower surface of the front substrate 12 where the second electrodes are formed is a second dielectric layer 17 formed to cover the second electrodes 12b. The dielectric layers 14 and 17 are formed in order to obtain a high discharge strength and memory effect by repeatedly generating avalanche discharge phenomena of wall charges on the surfaces of the dielectric layers. On the lower surface of the second dielectric layer 17 is formed a protection layer 18, which protects the dielectric layer 17 from damage by the sputtering of plasma particles and plays the role of lowering a discharge voltage and a maintenance voltage by secondary electron emission. A MgO thin film by deposition is generally used for the protection layer.

Meanwhile, a fluorescent layer 16 is formed on the surface of the barrier ribs 15 inside of the discharge cells 19 that are partitioned by the barrier ribs 15 and on the upper surface of the first dielectric layer 14, and an inert gas such as argon is filled inside of the discharge cells.

In observation of the plasma display panel with the structure as above, ultraviolet rays generated by the voltage applied between the electrodes 13a and 13b excite the fluorescent layer 16 that is formed inside of the discharge cells, and the fluorescent layer 16 emits visible light according to the principle of photoluminescence. Here, colors are displayed by red(R), green(G), and blue(B) fluorescent materials that are formed inside of the discharge cells.

Here, as described above, the second dielectric layer 17 is used to obtain a high discharge strength and memory effect, and a second dielectric layer based on PbO has been used in general. However, pinholes are easily formed on the surface of this dielectric layer, thus lowering the insulation characteristics. As a result, the production rate of defective panels in manufacturing plasma display panels becomes high.

### SUMMARY OF THE INVENTION

To solve the above problem, it is an objective of the present invention to provide a plasma display panel having a second dielectric layer whose light transmittance through the front substrate is excellent and whose interface characteristics are good and having improved image quality due to homogeneous discharge.

To achieve the above objective, the plasma display panel comprises: a rear substrate; a plurality of first electrodes formed on the inner side of the rear substrate; a first dielectric layer formed over the first electrodes and the rear substrate exposed between the first electrodes; barrier ribs with a predetermined height formed between the first electrodes on the first dielectric layer; a fluorescent layer formed on the side of the barrier ribs and on the dielectric layer between the barrier ribs; a front substrate that is joined to the rear substrate, thus forming discharge spaces partitioned by the barrier ribs; a plurality of second electrodes formed corresponding to the first electrodes on the inner side of the front substrate; and a second dielectric layer formed on the second electrodes and on the inner side of the front substrate exposed between the second electrodes that is composed of a dielectric material whose energy band gap is more than 6 eV and whose dielectric constant is less than 10.

In the plasma display panel of the present invention, a protection layer is preferably formed on the lower surface of the second dielectric layer, the second dielectric layer is formed to a thickness of more than 5 μm, and the protection layer is preferably formed to a thickness of more than 500 nm.

Therefore, breakdown of the dielectric layer can be reduced by forming on the front substrate a dielectric layer with a high breakdown voltage and good interface characteristics, and as a result, the cost of manufacturing a large quantity of plasma display panels can be reduced by improving the yield of non-defective panels, and the lifetime of the panel can be extended.

### BRIEF DESCRIPTION OF THE DRAWING(S)

The above objective of the present invention will become more apparent by describing in detail a preferred embodiment thereof with reference to the attached drawings in which:

FIG. 1 is a perspective view of a part of a prior plasma display panel;

FIG. 2 is a perspective view of a part of a plasma display panel according to an embodiment of the present invention; and

FIG. 3 is a view showing an experimental condition to find out the characteristics of a CaF₂ dielectric layer;

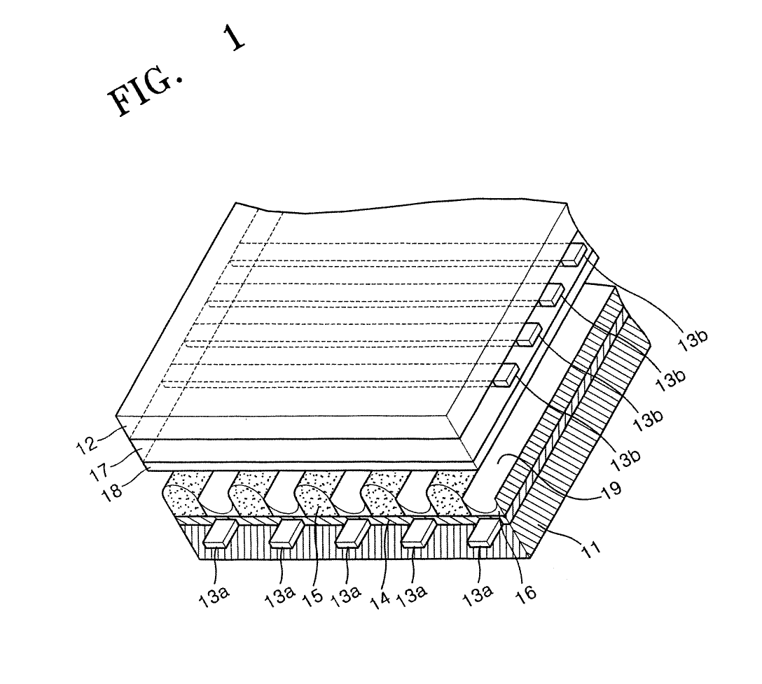

### DESCRIPTION OF THE PREFERRED EMBODIMENT(S)

Below, with reference to the figures, a preferred embodiment of a plasma display panel according to the present invention is explained in detail.

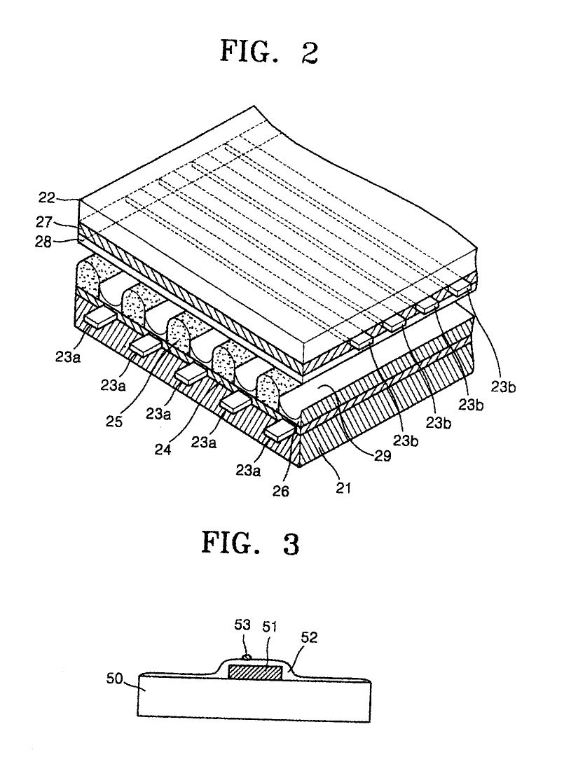

FIG. 2 shows a preferred embodiment of a plasma display panel according to the present invention where the second dielectric layer formed on the front substrate is composed of a CaF₂ thin film.

Referring to FIG. 2, a plurality of first and second electrodes 23a and 23b are formed with a stripe pattern on the inner side of each of front and rear substrates 21 and 22.

A first dielectric layer 24 is formed on the upper surface of the rear substrate 21 to cover the first electrodes 23a, and barrier ribs 25 are formed between the first electrodes 23a on the upper side of the first dielectric layer 24. Also, a fluorescent layer 26 is formed on the sides of the barrier ribs 25 and on the upper surface of the first dielectric layer 24. The electrodes 23a and 23b, the first dielectric layer 24, the barrier ribs 25 and the fluorescent layer 26 have the same functions as those in the conventional plasma display panel mentioned earlier.

Meanwhile, according to a preferred embodiment of the present invention, the second dielectric layer 27 that is composed of a CaF₂ thin film, and a MgO protection layer 28 are consecutively formed on the inner side of the front substrate 22. The material of the second dielectric layer 27 formed on the front substrate 22 (CaF₂) is different from that of the prior art and its thickness is more than 5 μm. This CaF₂ thin film has a large thermal expansion coefficient (26×10⁻⁶ cm/K), its light transmittance is excellent (the permissible thickness of light transmittance is 0.2-12 μm) and its interface characteristics are excellent. Also, on the lower surface of the second dielectric layer 27 composed of the CaF₂ thin film is the MgO protection layer 28 deposited by sputtering or electron beam deposition to a thickness of more than 500 μm.

To find out the characteristics of the CaF₂ dielectric layer, the surface and the cross section on which CaF₂ is deposited by electron beam deposition under the condition of FIG. 3 are examined and its insulation characteristics are also investigated. With reference to FIG. 3, a Ag electrode 51 is printed on the upper surface of a glass substrate 50, a CaF₂ thin film 52 is deposited over the resulting structure and a Cr electrode 53 is formed on the CaF₂ thin film 52 above the Ag electrode 51. The insulation characteristics are determined by measuring a breakdown voltage and its surface characteristics are compared with those of a transparent dielectric made of the conventional dielectric layer. By examining the pin hole, etc. found in the conventional dielectric body using this surface inspection, the lifetime and the homogeneity of images of the plasma display panel due to such pin hole, etc. can be anticipated. For its cross sectional characteristics, the distribution of thicknesses is measured.

Firstly, the result of measuring breakdown voltage after depositing CaF₂ showed that the breakdown voltage was three times higher than that of the conventional dielectric (30 V/μm or so). Secondly, in the case of the transparent dielectric formed by print method, etc., the pin hole, etc. where the voltage drop occurs rapidly are easily formed and an electron field is concentrated in the pin hole, etc., thus lowering the insulation characteristics, but in the case of CaF₂ deposition, the pin hole, etc. did not appear, thus reducing non-defective panels and extending the lifetime of the plasma display panel. Thirdly, for the cross sectional characteristics, the transmittance depends on the thickness, but the transmittance did not affect the performance of the plasma display panel even at thicknesses of 5 μm through 10 μm, which is thick enough to overcome the breakdown.

In the described preferred embodiment of the present invention, a CaF₂ thin film is representatively explained as the second dielectric layer formed on the front substrate, but as in the case of the CaF₂ dielectric layer, other thin films whose substrate component is a material with a large energy band gap (E_{g}: energy band gap >6 eV) and a low dielectric constant (ε: dielectric constant <10) show effects similar to the CaF₂ thin film. Such materials include oxides such as Al₂O₃ and ZnO and fluorides such as LiF, BaF₂, SrF, MgF₂.

As explained above, the breakdown voltage of the dielectric layer with excellent light transmittance and interface characteristics which is formed on the front substrate of the plasma display panel according to the present invention is higher than that of the prior art, and the pin hole, etc. are not formed on the surface, thus extending the lifetime of the plasma display panel and guaranteeing a homogeneous thin film protection layer. By omitting the processes of printing, drying and firing that are required in manufacturing the dielectric layer of the prior art, the manufacturing process can be simplified and the price of the panel can be lowered.

What is claimed is:

1. A plasma display panel comprising:
a rear substrate;
a plurality of first electrodes formed on the inner side of the rear substrate;
a first dielectric layer that is formed over the first electrodes and exposed portions of the rear substrate between the first electrodes;
barrier ribs with a predetermined height formed between the first electrodes on the first dielectric layer;
a fluorescent layer that is formed on the side of the barrier ribs and on the dielectric layer between the barrier ribs;
a front substrate that is joined to the rear substrate, thus forming discharge spaces partitioned by the barrier ribs;
a plurality of second electrodes formed corresponding to the first electrodes on the inner side of the front substrate; and
a second dielectric layer formed over the second electrodes and exposed portions of the front substrate between the second electrodes and composed of a dielectric material whose energy band gap is more than 6 eV and whose dielectric constant is less than 10.

2. The plasma display panel of claim 1, wherein
the second dielectric layer is composed of one material selected from the group consisting of CaF₂, LiF, BaF₂, SrF, MgF₂, Al₂O₃, and ZnO

3. The plasma display panel of claim 1, wherein
the thickness of the second dielectric layer is more than 5 μm.

4. The plasma display panel of claim 1 further comprising
a protection layer that is formed on the lower surface of the second dielectric layer.

5. The plasma display panel of claim 4, wherein
the protection layer is formed with MgO.

6. The plasma display panel of claim 4, wherein
the thickness of the protection layer is more than 500 μm.
